(19) United States
(12) Patent Application Publication
(10) Pub. No.: US 2005/0003893 A1
(43) Pub. Date: Jan. 6, 2005

(54) System and method for interactive wagering from a remote location

(76) Inventors: William Edward Hogwood, Washington Crossing, PA (US); Arthur John Dixon, Holland, PA (US); Peter John Carr, Hainault (GB); James Davis, Felden (GB); Steven Luigi Boffo, Romford (GB)

Correspondence Address: HOWREY SIMON ARNOLD & WHITE LLP, ATTEN: MARGARET P. DROSOS, DIRECTOR OF IP ADMIN, 2941 FAIRVIEW PARK DR, BOX 7, FALLS CHURCH, VA, 22042, US

(21) Appl. No.: 10/705,392

(22) Filed: Nov. 12, 2003

Related U.S. Application Data
(63) Continuation of application No. 10/371,197, filed on Feb. 24, 2003, now abandoned.
(60) Provisional application No. 60/358,387, filed on Feb. 22, 2002.

(51) Int. Cl. G06F 19/00; G06F 17/00

(52) U.S. Cl. 463/42

(57) ABSTRACT

A system and method for interactive wagering from a remote location. The invention may preferably be implemented on a multi-purpose device, and preferably uses a multi-purpose communication means, such that a dedicated terminal and/or dedicated line are not required. Various customizable features may be provided, allowing for user-friendly, interactive wagering and related communications between the remote location and an event location over a network, which may further include content locations and server locations, among others.

### RELATED APPLICATIONS

This application claims the benefit of U.S. Provisional Application No. 60/358,387, entitled SYSTEM AND METHOD FOR INTERACTIVE WAGERING FROM A REMOTE LOCATION, filed on Feb. 22, 2002. That application is hereby incorporated by reference in its entirety.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND OF THE INVENTION

1. Field of the Invention

The present invention relates generally to wagering. More specifically, the invention relates to interactive wagering from remote locations.

2. Related Art

The practice of wagering on the outcome of uncertain events has been with us for centuries. In addition to casino-type games, in which outcomes are often random or semi-random (e.g. based on a combination of skill and luck of the draw or roll), betting on contests of skill and/or ability has become quite common. For example, many people enjoy betting on such events as sports contests, including games like football, basketball, baseball, jai alai and others, and races between such competitors as auto drivers, dogs and horses. For many, a trip to the track has become a popular pastime, while others may even deem it their profession. However, it may sometimes be inconvenient to physically attend such events. Thus, there has long been a need for a way to place bets remotely.

Off-track betting establishments, which may be more numerous and/or more conveniently located than the event venues themselves, are generally known. In addition to receiving bets, these locations may further provide outcome information, such as by ticker or television broadcast.

Avenues are also available for placing bets for certain events by telephone. However, the systems that receive such wagers often do not provide any detailed event information, such as outcome details, racing programs or other paraphernalia, individual statistics, etc.

Another approach is to use dedicated devices such as the Tiny TIM, provided by Autotote Systems, Inc., of Newark, Del., or the BetMate device provided by AmTote, of Hunt Valley, Md. Such devices typically enable modem communications between an off-track betting location and an event location, through which bets may be made. Any feedback from such devices tends to be provided to users on simple displays, often making display of detailed event information difficult. Furthermore, such modem-to-modem arrangements are typically limited to local communications, as the costs associated with long-range diai-up communications tend to be prohibitive. Thus, these arrangements are undesirable, particularly for interstate, intercontinental, or other wide area wagering systems.

Other dedicated devices may receive event information over higher bandwidth channels, such as through a cable headend over a cable line, and thus provide richer information via a video display. Nonetheless, these dedicated devices are often expensive for individual users, and tend to lack a certain desired versatility. In today's environment of multi-purpose devices, consumers tend to shun relatively large devices that provide a relatively limited utility, and that tend to be relatively expensive, for such reasons as lower manufacturing volume than more versatile devices. Further, unlike these more versatile devices that tend to be covered by local technical agents, maintenance support for a dedicated wagering terminal would be expensive and would be difficult to offer worldwide, as is desirable.

What is needed is a cost-effective solution for communicating wagering and/or event information between remote locations and a central location or locations. The remote locations are preferably enabled for use both in the domestic (home/office) environment and the retail sector. For reduced cost, the invention preferably uses off the shelf hardware products at the remote locations, rather than purpose-built, wagering terminals with fixed data connections.

### SUMMARY OF THE INVENTION

The present invention provides a system and method for interactive wagering from a location that may be remote from an event being wagered upon. The invention is preferably implemented on a multi-purpose device, and preferably uses a multi-purpose communication means, such that a dedicated terminal and/or dedicated line are not required. Various user-customizable features may be provided.

In one aspect, the invention is designed to function on a store-bought, Internet-ready PC with a Windows® operating system. All data communications requirements of are preferably conducted through Internet connections. In embodiments where a dial-up connection to an Internet service provider (ISP) is used, this may allow mere local call charges for inter-continental data movement. In embodiments where a dedicated line, such as a digital subscriber line (DSL), cable line, etc., is used, even these charges may be avoided. Optionally, further functionality associated with a purpose-built wagering terminal may be provided by including with a remote terminal such devices as a receipt printer, barcode scanner, credit card reader, etc.

In another aspect, the invention preferably allows wagering based on a deposit account, whereby funds are registered to an account number in advance of wagering taking place. The user can stake wagers up to the value held on deposit. Arrangements may also be made for borrowing funds under any of a variety of circumstances. The stakes for all accepted wagers may then be debited from the account at the time the bet is acknowledged as being struck. All winnings are preferably automatically credited to the account upon the relevant event location signifying the event is over and that payout may take place.

In another aspect, the invention can serve the requirements of both the home user and the retail operator. For home use, there is not a requirement to issue receipts, although they may be if desired. In addition, so that the home user can be selective as to which bet details are retained for reference, the user may be given the ability to save and recall bet files as required. Conversely, the retail version might utilize a receipt printer and maintain a 31-day bet file with individual bet settlement detail, for example.

In yet another aspect, the invention may be implemented through an application that can initially be loaded on a PC by running a set-up program from a CD or by connecting to a network location, such as a web site, over a network such as the Internet. Users may achieve upgrades to the application individually, such as by replacing an executable file, which can be sent via e-mail or download, for example. Alternatively, the network location may be updated centrally to the benefit of all subsequent users.

### BRIEF DESCRIPTION OF THE FIGURES

The invention may be better understood with reference to the following figures. The figures are intended to be illustrative rather than limiting, emphasis instead being placed upon broadly illustrating the principles of the invention.

FIG. 1 is a block diagram of an embodiment of a system of the present invention;

FIG. 2 illustrates an embodiment of a home page of the present invention;

FIG. 3 illustrates an embodiment of a view ticket page in accordance with the present invention;

FIGS. 4A-4F illustrate embodiments of various preference pages in accordance with the present invention;

FIGS. 5A-5C illustrate embodiments of today's racing pages in accordance with the present invention;

FIGS. 6A and 6B illustrate embodiments of exacta bet entry pages of the present invention;

FIG. 7 illustrates an embodiment of a trifecta bet entry page in accordance with the present invention;

FIG. 8 illustrates an embodiment of a superfecta bet entry page in accordance with the present invention;

FIG. 9 illustrates an embodiment of a daily double bet entry page in accordance with the present invention;

FIG. 10 illustrates an embodiment of a daily double grid bet entry page in accordance with the present invention;

FIG. 11 illustrates an embodiment of a pick 3 bet entry page in accordance with the present invention;

FIG. 12 illustrates an embodiment of a pick 6 bet entry page in accordance with the present invention; and

FIGS. 13A and 13B illustrate embodiments of pick 9 bet entry pages in accordance with the present invention.

### DETAILED DESCRIPTION OF THE PREFERRED EMBODIMENTS

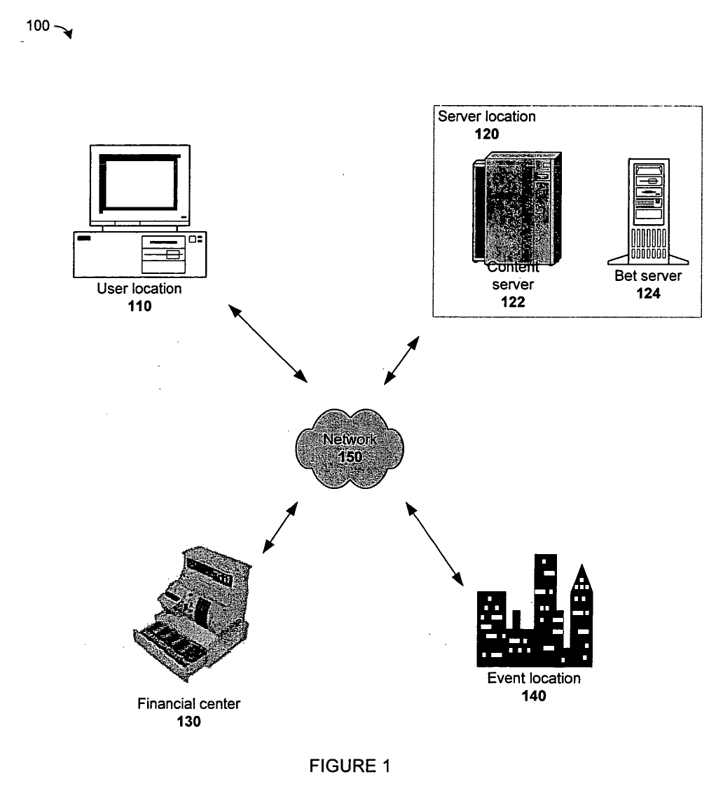

In one embodiment, illustrated by FIG. 1, a system 100 of the present invention preferably couples a user location 110, a server location 120 which may include a content server 122 and a bet server 124, a financial center 130 and an event location 140 over a network 150.

The user location 110, of which there will typically be a plurality, is preferably located remotely from the server location 120 and event location 140, such as in a user's home or office. For example, the user location 110 may be a personal computer (PC). Of course, the user location 110 could also be at the event location 140, which may or may not be commonly located the server location 120. Furthermore, multiple server locations 120 may be provided, each of which preferably provides content and bet serving functionality, but which need not include discrete content servers 122 and bet servers 124. Likewise, financial services functionality is preferably, but not necessarily, provided in the system 100 by any desired means. For example, accounting, lending and related services may be provided by an independent financial center 130 as illustrated, or they may be incorporated into one of the other locations, such as the server location 120.

The event location 140 preferably represents a location of an event or events to be wagered upon. The event location may provide bet receiving and settlement functionality. Alternatively, these functions may be provided by the bet server 124, while the event location provides upcoming event and/or event result information thereto, and/or directly or indirectly to a user.

The network 150 may be any network, public or private, local or wide-area, or others. For example, the network 150 may be the global combination of networks known as the Internet. Thus, the network 150 may include devices communicating by such means as hard wire transmission, satellite, wireless, etc. To that end, the user location 110 may further include any device capable of communication over the Internet or other desired network, such as a laptop computer, mobile telephone or other wireless device, personal digital assistant (PDA), etc. Optionally, means for providing distinct receipts, such as a bar-coded receipt printer, and/or a means for reading the same, such as a scanner, may also be provided.

Upon desiring to utilize the present invention, a user preferably initiates a network connection, such as an Internet connection, and establishes connectivity to the content server 122 and bet server 124 via the server location 120. The content server 122 preferably provides the data required to drive the application, while the bet server preferably provides a gateway to a wagering system, which may be supported at the event location 140 or elsewhere.

In one embodiment, so as to be user friendly, a system or device at the user location 110 is provided with an application that operates under similar navigational techniques as does Windows Explorer® or a comparable web browser. For example, the application may be a software program loaded onto a user's PC, PDA or other device of choice.

Alternatively, the application may be supported at a server side of the system, such as at the server location 120, with only a user interface being supported at the user location 110. The interface at the user location 110 may be communicated over the Internet or other network in a manner that conforms to a transmission control protocol/ Internet protocol (TCP/IP), such as by hypertext transfer protocol (HTTP) or other desired format. For example, as will be appreciated by one skilled in the art, a web page or series thereof in hypertext mark-up language (HTML), extensible mark-up language (XML), etc., may be served to the user in response to a request from the user's system.

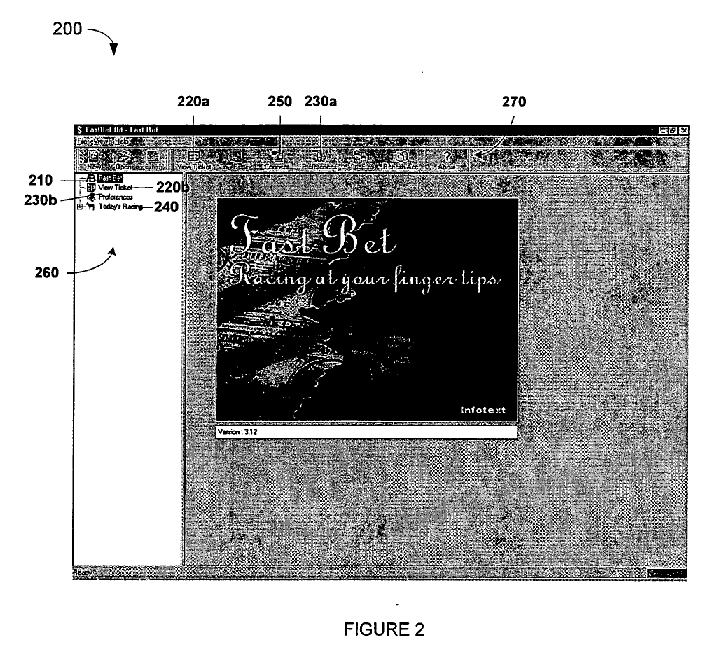

Regardless, upon initiation of the application, the user is preferably presented with an introductory view, such as a start-up page of a software program, an Internet home page, etc. An embodiment of such an intro page or home page 200 is illustrated in FIG. 2. In this embodiment, as in many embodiments illustrated therein, the page is directed toward horse racing. However, this is for illustrative purposes only, as one skilled in the art will readily appreciate that the invention is applicable to any event upon which wagers may be placed.

As shown in FIG. 2, the user may be presented with number of options, including fastbet 210, for initiating a session; view ticket 220a and 220b, for taking the user to the current (open) bet file; preferences 230a and 230b, for allowing the user to set up application details (discussed below), and today's racing 240, for viewing racing activity. As can be seen, certain options may be presented both in a file tree format 260 and on a tool bar 270. For use in an application supported initially on the user's system, a connect 250 option may be provided as well for initiating contact with a server of the present invention. In establishing an Internet connection, users' IP login information may be required.

The intro page 200 may be better suited for use by a home user as opposed to a retail user, but is applicable to both and other environments. Using the intro page 200, the user preferably has the ability to manage files of bets. For example, a series of bets can be saved under a file name and new files can be set up and opened.

The toolbar 270 at the top of the page preferably also allows the user options including new 280, for creating a new file, open 285, for opening an existing file, and save 290 for saving a currently open file. In one embodiment, these functions are only available to the home user, while for a retail user, the application automatically creates a file and saves ticket details on a monthly or other periodic or otherwise selected basis. Of course, other options may be presented as well, whether visually or by shortcut, for example, such as a betting option for taking the user back to a previously selected race card, a meeting files option for requesting an update of meeting files for receiving all data transmitted during a period of off-line use of the system (preferably automated in a retail application), and a refresh account option, which preferably requests an update to the user's account balance after wagers are deducted and winnings are credited, among other transactions.

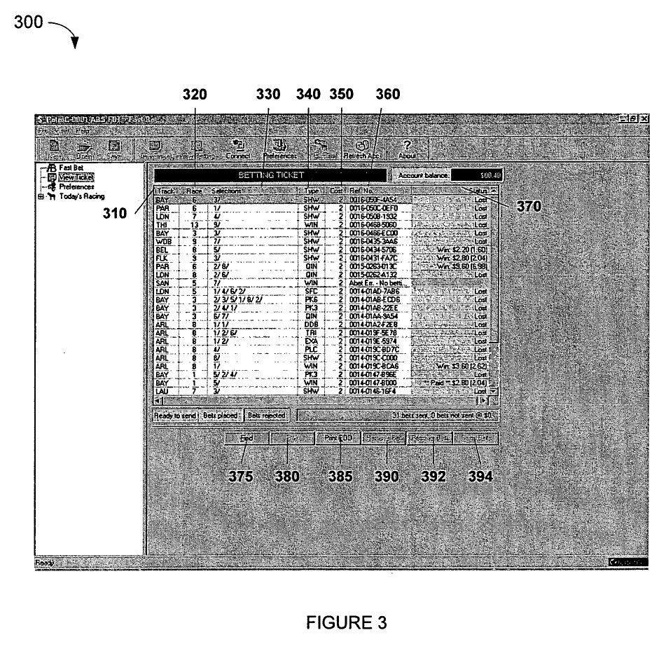

Upon selection of the view ticket option 220a or 220b, the user is preferably presented with a view ticket page, an embodiment of which is illustrated as a view ticket page 300 in FIG. 3. The view ticket function preferably allows the user to view a summary of wagers. The home user might see the particular file open, while the retail user might see wagers for the last month or other desired time period. Again, however, the present invention is not limited to such distinctions between individual or home user, retail user, and other implementations.

Referring to FIG. 3, the following list provides a sampling of potential view areas that may be revealed in an embodiment of a view ticket page 300: track 310 (3-character literal ID, e.g. PHI=Philadelphia Park); race 320 (a race number wagered upon); selections 330 (runner numbers, punctuated by “/” or other selected symbol); type 340 (3-character literal ID of the bet type; e.g., SFC=Superfecta); cost 350 (total cost of the transaction); ref. no. 360 (unique bet reference ID); and status 370 (status of transaction between user and server). Regarding the bet ref ID, this may be generated either at a pari-mutuel hub or from the user location, such as for already “booked” bets. Of course, the views illustrated and described above, as well as others described below, are by way of example only. Views may be varied as desired depending on a particular user, on a betting environment (e.g., for other racing and non-racing environments), for differing types of wager, etc.

A status applied to a transaction may be any of the following or others: Not resolved—the transaction has not been requested for settlement, or the event location 140, which may in this embodiment be a host track for example, has not cleared the result for settlement. Lost—the transaction has been settled by the Host Track and has a Zero return to the customer. Win—win certain dollar amount (value preferably in the user's local currency) or in multiple currencies (further discussed below with regard to preferences). Paid Win—the user can flag a bet with a positive as “paid.” In one embodiment, such an option is limited to a retail use. Booked bet—a status of “booked” is preferably applied to a bet that, in a retail embodiment for example, a “bookmaker” has chosen to stand the liability, win or lose, rather than to co-mingle the wager back to the host track.

In one embodiment, co-mingling of wagers is used as a mechanism for placing wagers back to a host track pari-mutuel system. Upon receipt of a bet transaction detail, the pari-mutuel hub might determine a validity of the transaction by considering such conditions as 1) whether the event is open for wagering, 2) whether the total stake is available as a deposited fund, 3) whether the selected bet type (e.g., pool) is available on the requested event, etc. Upon such validation, a unique bet reference ID is preferably issued, and may be transmitted back to the user location 110, for example.

Other transaction statuses may be represented in other ways if desired. By way of example and not of limitation, varying background colors for various fields may be used, e.g., red background (ready to send)—identifies a transaction that has been created off-line from the Internet. Any bet with a “ready to send” status is preferably sent to the server location 120 or event location 140 by user action, such as the activation of a “send bets” option. Blue background (bet placed)—all valid transactions accepted preferably will have a blue background status. Yellow background (bet rejected)—if a bet is rejected, the background status will be yellow. This may occur for a late bet, a connectivity failure, a bet placed against a pool that is no longer available, a bet that overdraws the user's account, etc.

With continued reference to FIG. 3, upon selecting find 375, a user is preferably presented with any entry mechanism requiring a desired bet number to be entered. The application preferably scans all bet numbers and locates the match and highlights a matched bet, such as by a distinct background. If no such bet number is present, the application may respond by stating that the bet could not be found. If the system has bar-coded receipts and a scanner the process can be conducted by reading the barcode, while the manual method preferably continues to be available in event of damaged receipts, for example.

A pay option 380 is preferably also made available for any bet that has a win status. Upon finding a bet that has been won, whether by utilising manual scrolling, the find option 375, barcode scanning, etc., the bet is preferably indicated in some way, such as by a blue highlight background. If there is a payout value, the pay option 380 will preferably be available. If the bet has any other status other than win, the pay option 380 will preferably be greyed out. If the transaction has a status of paid win, for example, it will not permit the bet to be paid a second time.

Upon selecting pay 380, the amount to pay is preferably displayed in both US dollars and the local currency. The local currency may be converted as per the exchange rate entered through the preference interface discussed below. Upon payment, the status preferably changes from win to paid win.

Selecting the EOD (End Of Day) option 385 preferably generates a printout, such as on an optional receipt printer detailing such items as name of bookmaker or operator; ID number of the specific event site; day, date & time; total number of co-mingled bets struck that day, bet reference numbers and total stake (including tax if applicable) and total stakes for co-mingled bets, booked bets and bets of any other type; bet reference numbers and total payout value for paid winning and unpaid winning bets; total winnings; total tax; and balance (with and without tax). All values shown are preferably in a user's local currency using a preferred exchange rate.

In one embodiment, it is possible for a home user to create bets off-line. Thus, a remove bet option 390 may be provided for use before connecting to the Internet or before establishing a connection with the server location 120, so as to not send bets that are not required and/or desired. If a bet is rejected due a race being closed or the pool being no longer available the bet may carry a yellow background status, for example. As this bet is not in the system the user can remove it from the file, thus allowing the user to view only valid bets.

To simplify a bet settlement function of the present invention, a user may instigate a bet resolve process. Upon selecting resolve bets 392, any transaction with a “not resolved” status will preferably have its reference number transmitted to the server location 120, or wherever such matters are resolved in a particular embodiment, for evaluation. The location can preferably return any of at least three statuses: 1) Not resolved—status remains unchanged due to result or result clearance still to be confirmed from the event location, such as the host track; 2) Lost—host track has determined that the transaction has a zero return; or 3) Win—settlement determined from the host track, shown in both US$ and local currency.

After a user has determined that a bet is required in the off-line mode, clicking on a send bets link 394 will preferably establish an Internet connection, if the user is using an implementation in which such a connection is not continuous, and transmit all bets with a status of “ready to send.”

An account balance is preferably also shown in the view ticket mode. The account may be the summary of all wagers that are co-mingled, for example. Winnings are preferably automatically accredited to the account from the server or financial center 130 without the user requesting a resolve of bets. The balance may be shown in any desired currency.

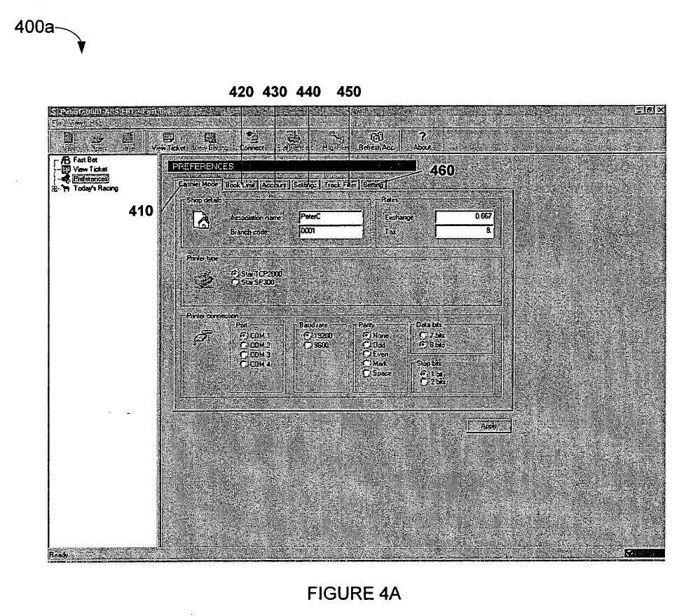

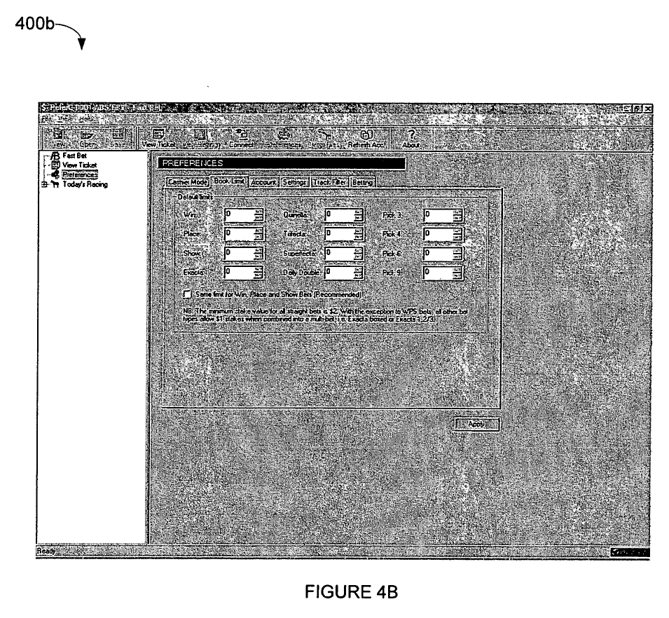

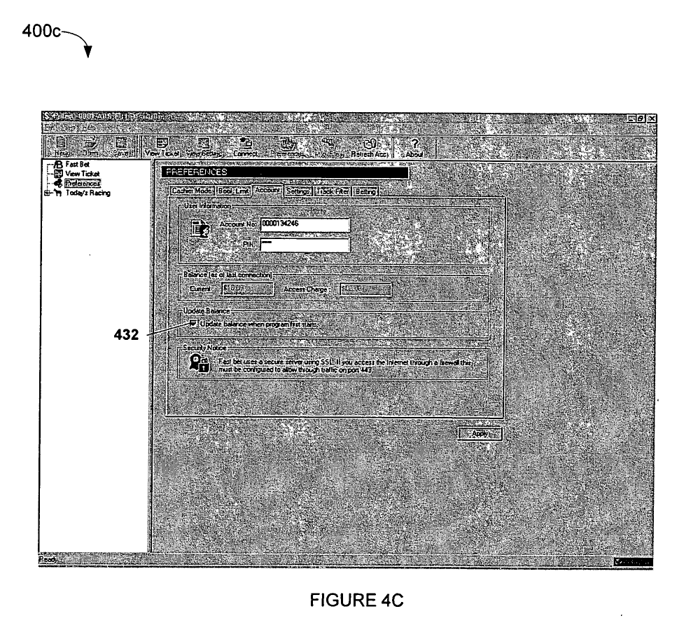

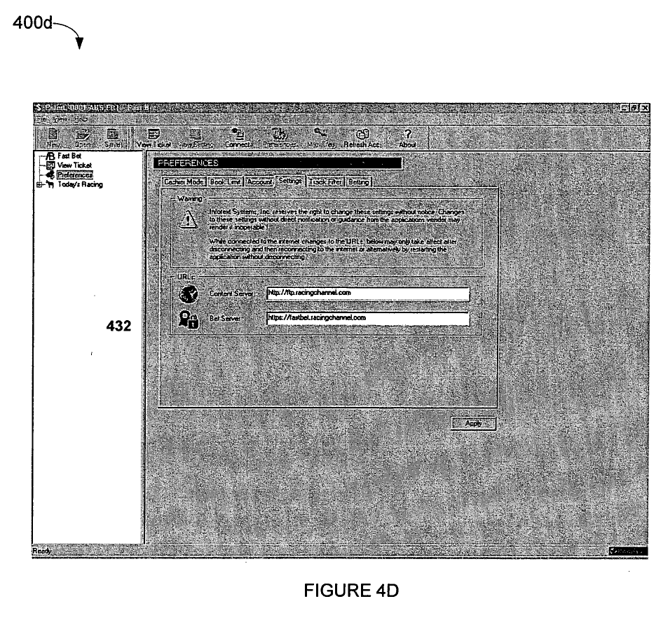

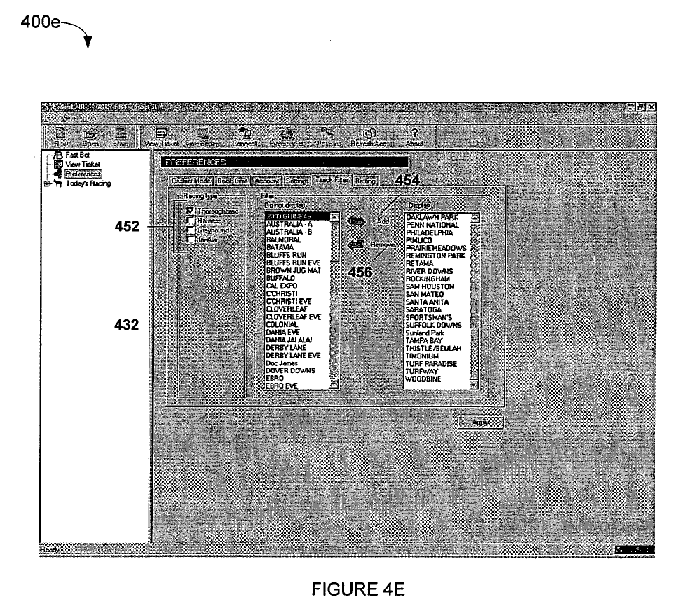

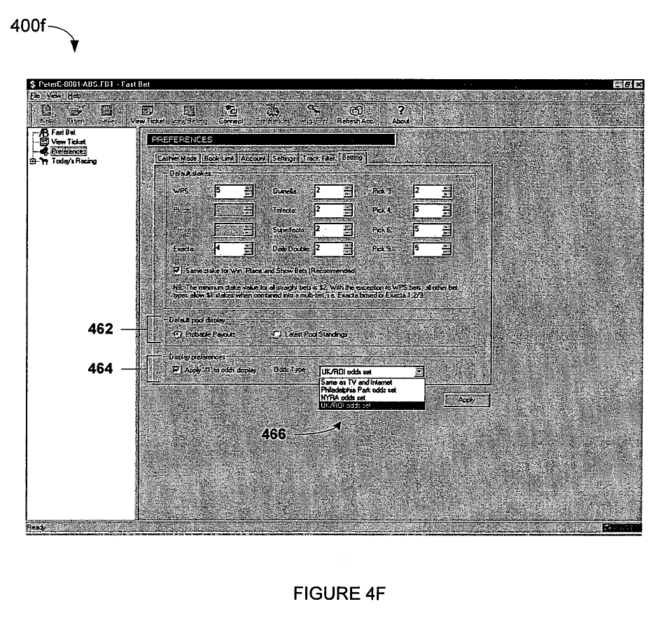

Various user preferences that may be tailored by a user, preferably accessible by clicking on preferences 230a or 230b, will now be described with respect to FIGS. 4A-4F. An embodiment of a view of a preference page is shown in FIG. 4A. As can be seen, such options as cashier mode 410, book limit 420, account 430, settings 440, track filter 450 and betting 460 may be provided. FIG. 4A illustrates the cashier mode view 400a.

The cashier mode is preferably made available when a printer, such as a bar-coded receipt printer, is attached. A user can preferably enter such information as the following: association name (preferably appears on a customer's receipt for reference), branch ID (such as to provide a further reference to the customer), exchange rate and local tax rate, among other details. The user can also preferably enter the printer attached by name. As more printers are accommodated, the list of available printers will increase. If the desired receipt printer required is not listed, the user can enter such printer connection details as corn port, baud rate, parity, data bits and stop bits. Clicking on apply activates the details entered, thereby overriding any previous details.

Selecting book limit 420 preferably reveals a page view such as the book limit view 400b illustrated in FIG. 4B. In a retail environment, for example, a bookmaker may choose to “book” certain bets rather than co-mingle them back to other pools. The book limit view 400b preferably provides an interface by which a user can set thresholds for each individual pool bet type so as to automate the process. If the threshold of all bet types is $0 then all bets will co-mingle. If the threshold is $50 for each bet, then only bets in excess of $50 will be co-mingled to the pools. The user can select any value for any pool bet type. A sample configuration might be:
$50 Win Place & Show
$25 Exacta & Quinella
$5 Trifecta
$0 All others

Booked bets preferably produce a receipt as per a co-mingled bet, but the reference number may be generated locally within the application, such as when the application is a software program or script running independently on the user's system. Alternatively, the number may be generated from a pari-mutuel hub.

Upon selecting the account option 430, a user is preferably presented with a page view comparable to the account view 400c of FIG. 4C. This view preferably allows the user to input his or her account number and personal identification number (PIN). Both of these numbers may be used to validate access to a system of the present invention. The account view 400c may also show the latest on-line account balance, any fee applied to access an account balance, etc. The user further preferably has the option to automatically obtain an account balance upon start-up, which may be achieved in this embodiment by ticking an update balance box 432.

In one embodiment, a user has on his or her system an application that acts as an interface to a system of the present invention. Thus, it may be desirable to provide a settings page, an embodiment of which is illustrated as a settings view 400d in FIG. 4D. This view preferably allows the user to designate a network address that represents a location of a server 120 of the present invention. As shown, uniform resource locators (URLs) for the content server 122 and bet server 124 may also be entered. Again, these servers may be commonly located with or remotely located from each other. In one embodiment, the application only utilizes one content server 122. In another embodiment, additional content servers 122 may be added and thus additional addresses inserted using the settings view 400d. Multiple servers could be accessed to expand the functionality beyond a single pari-mutuel wagering application, for example.

Referring next to FIG. 4E, an embodiment of a track filter view 400e is illustrated. Because the present invention may be used to access totalisators associated with wagering data for a wide variety of events, it may be desirable to limit displayed data to a particular user's interests. For example, a user may limit the data to only official horse and dog based wagering, or to Jai Alai. In the embodiment illustrated, the filtering is achieved by the tick boxes 452 associated with thoroughbred, harness and greyhound racing, as well as jai alai. Of course, countless other options may be available. Ticking the required boxes 452 preferably restricts the display to cover only that specific wagering type or types, as multiple or all wagering types can be selected. Furthermore, individual track requirements can be managed by using add and remove tiles 454 and 456, allowing the user to tailor the display to specific tracks regardless of wagering type.

Selecting betting 460 preferably reveals a page view such as the betting view 400f illustrated in FIG. 4F. The betting view preferably allows the user to load default stake values for individual bet types. This action assumes the stake when a bet detail is entered. Of course, the defaults can be over-written, if desired, at the time of striking the bet, such as by clicking on stake and selecting a different value or by entering the required stake into the stake box. Additional options may be provided regarding presentation of the latest tracks wagering. Default pool display buttons 462 are illustrated for the purpose of selecting between them. For example, it can show the probable payouts to a $2 stake or it can show the latest pool standings. Other options may be made available as well.

Regarding the display preferences portion 464, betting odds can be shown with or without the inclusion of the “/1” if desired. For example, five to one odds could be shown either as “5” or “5/1.” Likewise, odds formats may be selected between such options as ‘same as TV and Internet,’ ‘Philadelphia Park,’ ‘New York Racing Association (NYRA)’ and ‘United Kingdom & Republic of Ireland,’ among others, using an odds type pull down menu 466.

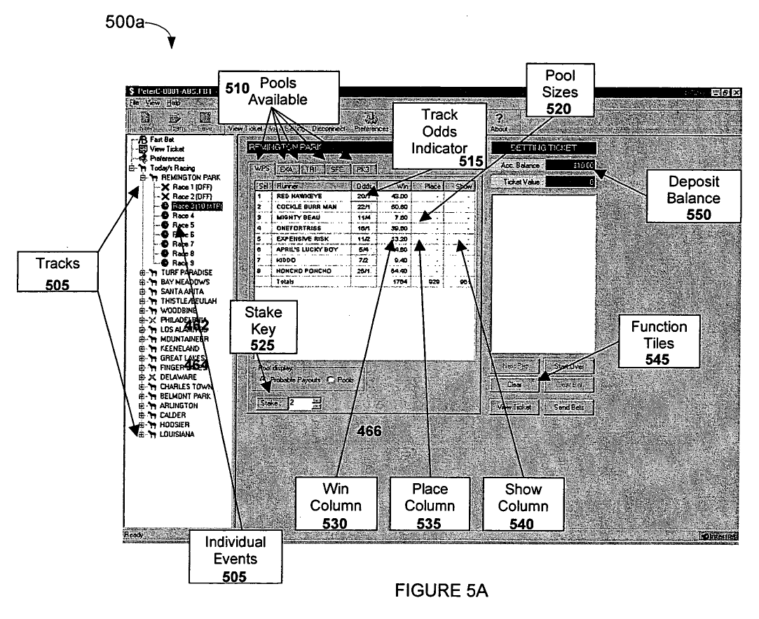

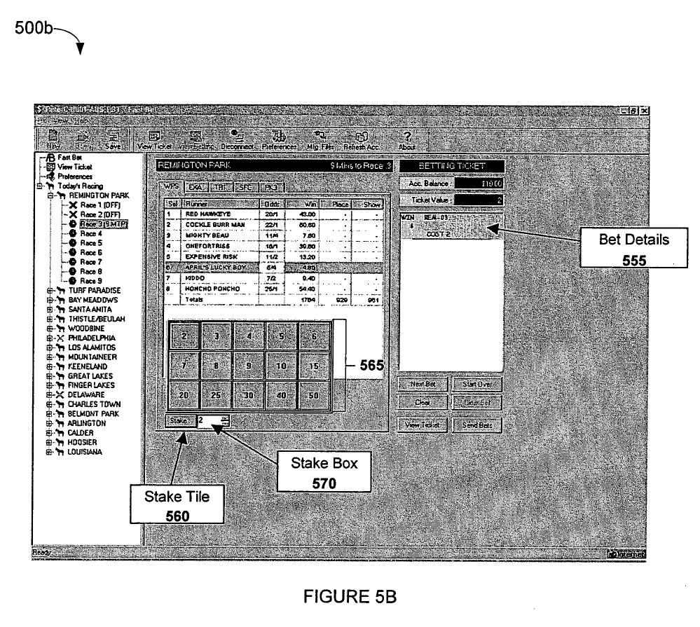

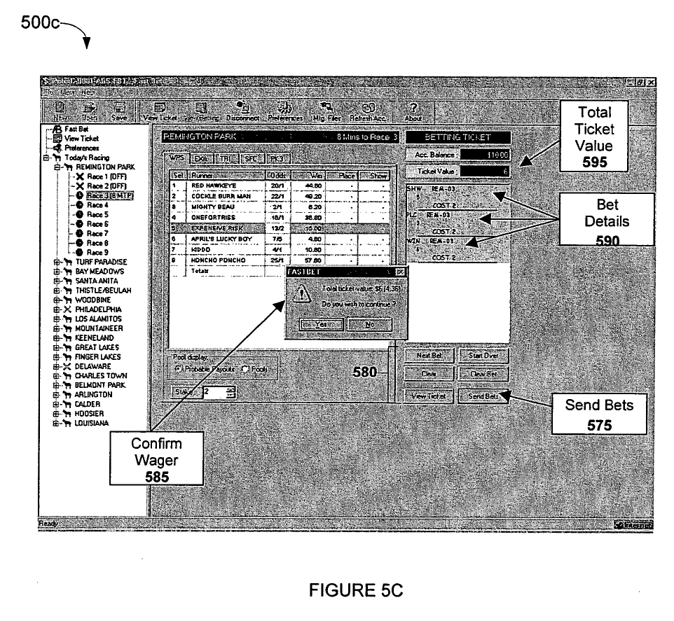

Referring next to FIGS. 5A-5C, various embodiments of a system and method of the present invention for interactive wagering will be described. FIG. 5A illustrates a today's racing page 500a, preferably displayed when a user selects a today's racing link 240a or 240b. Upon connection to the content server 122, the application preferably determines what data is required. In one embodiment, this is achieved by the application knowing the sequential number of the last data packet it received. A request may then be submitted to obtain all subsequent data beyond that last received packet. This approach to data set-up car enable the user to come off-line and upon re-establishing communications quickly get back up to date.

Data exchanged in accordance with the present invention may be in any suitable format. As discussed above, data packets or records may be used. The data packets preferably conform to a predefined specification, which may provide a strict record definition and/or allow variable length, structure, etc. In one embodiment, the first three fields of most record types contain a common structure. The first is a record code that describes the record level and forms a part of a packet identifier. The second is a record sub code that combines with the record code to form the unique packet identifier. The third is a meeting code, which is preferably a unique code that may be used to identify a race meeting, for example. Preferably, once the code is defined in a meeting record, it remains constant and is used throughout subsequent packets as a means of referral.

Meeting codes may also be further predefined. In one embodiment, meeting codes consist of 8 alphanumeric characters and are unique for each meeting. Preferably, for compatibility with existing systems, the code will contain sufficient redundancy so as to allow a variety of processing methods. The code may be made up as shown in Table 1, for example:

TABLE 1

| Char | Key 1 | Key 2 | Key 3 | Content |
|---|---|---|---|---|
| 1 | Main key | | | Year code (0 = 2000, 1 = |
| | (SDS | | | 2001, etc.) |
| 2 | style) | | | Any hexadecimal digit 0-9 or |
| 3 | style) | | | A-F. Each combination will |
| 4 | | | | be unique within a calendar |
| | | | | year. (Allows approx 45,000 |
| | | | | meetings per year). |
| 5 | | Alternative | | Month code (A = Jan, B = |
| | | key | | Feb, . . . L = Dec) |
| 6 | | | | Day code (1 = 1^{st}, . . . |
| | | | | 9 = 9^{th}, A = |
| | | | | 10^{th}, . . . U = |
| | | | | 31^{st} |
| 7 | | | Daily | Batch no (1, 2, 3, etc.) |
| 8 | | | key | Daily meeting code (A, B, |
| | | | (RAW | C, etc.) |
| | | | style) | |

Potential methods of use for one embodiment are as follows:
Main key. This key is preferably compatible with software that supports a suitable data feed, such as the SIS Sports Data Service feed. The key preferably consists of 4 hexadecimal digits, the first of which is (by convention) a code for the current year. Clients using this key may ignore the other 4 characters, but might need to build some form of meeting table in their database. This will allow, for example, all of the meetings on a particular day to be located and enumerated.
Alternative key. In one embodiment, this key is larger but provides a built-in date structure. It consists of 5 characters, 3 of which represent the meeting's performance date, and two of which provide a sequencer (described below) into the meetings for that date. Users of this key may ignore the 3 hexadecimal characters used by the main key.
Daily key. This key is preferably compatible with software that supports a raw data feed, such as the original SIS Raw Data feed. To use this method, clients may filter the data for the current day's meetings only. The year, month and day codes can be used to achieve this. The key preferably consists of a two-character sequencer only, and this is based upon the original SIS Raw feeds use of a single letter A to X. However, some events consist of substantially more than 24 meetings per day. To support more meetings than this, the feed preferably utilizes a second ‘batch number’ character. The meetings of the day will therefore be numbered 1A, 1B, . . . 1X, 2A, . . . 2X, 3A, . . . , etc., or by some other suitable convention.

If a particular track operates two meetings on the same day (e.g. an afternoon and an evening meeting), for example, then these will preferably be allocated separate keys under all three methods. Again, however, as one skilled in the art will readily appreciate, the above data specification description is by way of example only. Many alternatives are available depending on a particular implementation of the invention.

Regardless of a chosen data format, the content server 122 is preferably responsible for delivering the raw data from which the user's application builds the user interface. As discussed above, this data may be used by an application running on the user's system, or may include all or most necessary data, such as in the form of a page or pages in an appropriate mark-up language for use by a browser application, for example. Regardless, incorporated within the data feed are preferably static details, which may define the meeting, events and pools, and live updates, among other things, detailing snapshots of the win pool. These features may be depicted as odds and pool sizes for place, show, exacta, quinella, etc. Having determined event coverage required via the track filter, discussed above, the application will preferably apply these filters to the data feed received.

On the today's racing page 500a, a list of tracks or other locations holding races or other events that day is preferably illustrated in a track portion 505. After applying the track filter to achieve a list of tracks of interest and that have events, each wagering type is preferably depicted with a symbol to indicate such details as racehorse, harness rig, greyhound, etc. When a track has completed all its events, the symbol is preferably replaced with an “x” or other indicator to show that no further events are available. All tracks in the track portion 505 preferably have a “+” symbol that can be clicked on to expand the data shown.

Utilizing this Windows Explorer® or other browser-type navigation, each track can preferably be expanded to show the events taking place at a certain location. Before any live updates are received, the expansion might show Race 1, Race 2 . . . Race 10, for example, to show the total number of events scheduled at the selected venue. As racing progresses the status of the next event might be updated with a minutes to post (MTP) record indicating how long until the next race is scheduled. The MTP record could appear, for example, as: Race 3 (23MTP). Nearer to the race time, the MTP status might change to “P/T” for Post Time. The P/T might then subsequently change to “OFF,” indicating pool closure. An additional symbol, such as a red “x” appearing next to the event, could also show the off status.

With continued reference to FIG. 5A, it may be seen that in this embodiment, the today's racing page 500a includes a pools available portion 510, indicating which pari-mutuel pools are available for a selected individual event. This information may be obtained by the application from the data feeds provided by the server location 120, for example. Such pools, some of which are illustrated in FIG. 5, might include win (W)—nominating the selection to finish in 1^{st} position; place (P)—nominating the selection to finish in 1^{st} or 2^{nd} position; show (S)—nominating the selection to finish in 1^{st} or 2^{nd} or 3^{rd} position; exacta (EXA)—nominating 1^{st} & 2^{nd} to finish in correct order; quinella (QIN)—nominating 1^{st} & 2^{nd} to finish in either order; trifecta (TRI)—nominating 1^{st}, 2^{nd} & 3^{rd} to finish in correct order; superfecta (SFC)—nominating 1^{st}, 2^{nd}, 3^{rd} & 4^{th} to finish in correct order; daily double (DDB)—nominating the 1^{st} places in 2 designated races; pick 3 (PK3)—nominating the 1^{st} places in 3 designated races; pick 6 (PK6)—nominating the 1^{st} places in 6 designated races; pick 9 (PK9)—nominating the 1^{st} places in 9 designated races; among others.

As illustrated, for each type of bet, odds are shown in a track odds indicator column 515 for each entrant. In addition, pool sizes 520 for various bets are shown for a current stake, indicated by a stake portion 525. For example, in the embodiment of today's racing page 500, a win column 530, a place column 535 and a show column 540 are shown. Function tiles 545 and a deposit balance indicator 550 are also provided, as discussed previously.

Assuming that WPS are valid pools, the user might click in the appropriate column (WPS) for the requested selection. In FIG. 5B, an embodiment of a today's racing page 500b is shown. Clicking within the win column 530 of FIG. 5A preferably produces bet details such as those shown in the details portion 555. The stake unit applied will be as per the default win stake applied in a user's preferences/betting information. If the stake requires changing, pressing the stake tile 560 preferably reveals the available stake calibration 565. For example, values of $2, $3, $4, $5, $6, $7, $8, $9, $10, $15, $20, $25, $30, $40 and $50 might be available. If the required stake is not shown, it can preferably be simply entered in the stake box 570.

Referring to today's racing page 500c of FIG. 5C, an example is shown in which WPS bets are placed for a customer, in a retail situation, by a user (e.g. a bookmaker) as follows: $2 on number 6 to win, $2 on number 3 to place and $2 on number 5 to show. Upon confirming these details, the user commits them for co-mingling (assuming “0” threshold for booked bets) by pressing the send bets tile 575 of the bet options portion 580. As above, details are preferably provided in a bet details portion 590, while a total ticket value may be shown in a total portion 595.

At this point, the system or systems preferably require the user to confirm the total stake, which is shown in both US dollars and the value determined by applying the exchange rate and tax rate entered through user preferences. Upon confirmation from the customer, the user presses yes in a confirmation box 585. The system ascertains that there are sufficient funds available for the wager(s) and upon verification, the transactions details are preferably transmitted to the server location 120, or other relevant location. If insufficient funds are available, this would preferably be reported to the user and the wager or wagers not permitted.

Preferably, as illustrated in the bet options portion 580, the user has options including the following: Next bet—allows the user to move on to another event or wager type having secured the bet detail without transmitting them to the server location 120. Start over—allows the user to scrap all bet details entered that have not been transmitted and start over again. Clear—fulfills the same function as start over but restricts the clear to highlighted bets. Clear bet—allows the user to remove an individual bet from those that are ready to send. View ticket—moves the user to the view ticket mode. Send bet—transmits all bets to the hub when in an online mode or flags them as ready to send when in offline mode. Of course, one skilled in the art will appreciate that these options are not limiting, as many others are possible.

Upon receipt of an acknowledgement from the server location 120 or other relevant location, a confirmation is preferably shown and a receipt printed (if printing means are attached). The application then might query if the user wants to switch to view ticket mode or to continue from the event-wagering screen, for example. The user's deposit balance is preferably also adjusted to reflect the total cost of the wagers transmitted.

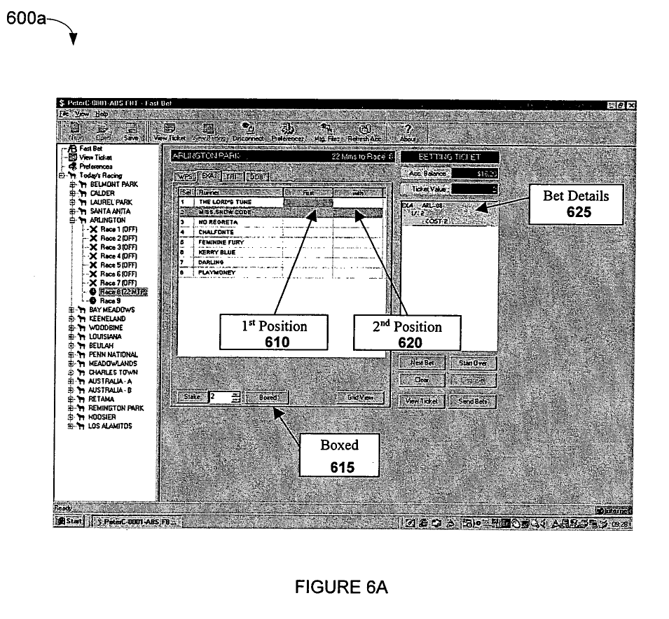

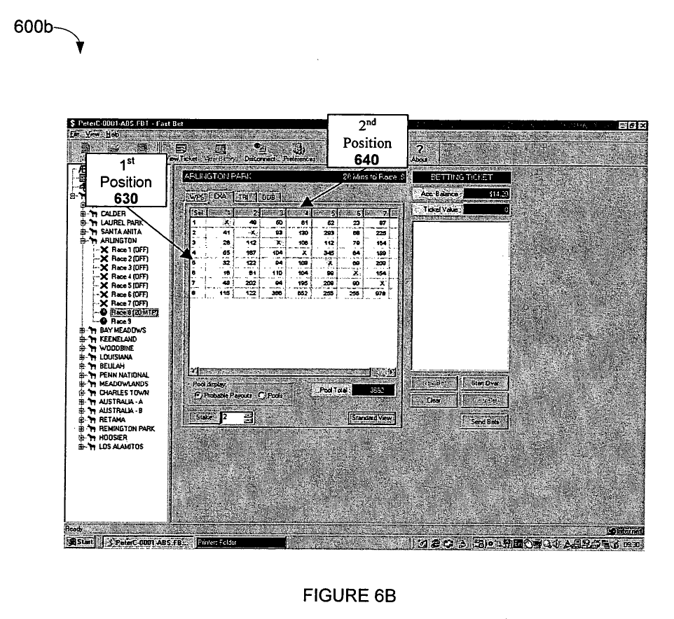

With reference to FIGS. 6A and 6B, embodiments of views that may be presented for varying bet types will be described. Preferably, for simplicity, the same or similar pattern of validation, confirmation and acknowledgement exists regardless of a wager type selected. While different wager types might have different selection entry routines, staking and/or other features may be constant. Of course, this need not be the case if such is not desired, as a wide degree of customization is contemplated with regard to the present invention.

Referring to FIGS. 6A and 6B, embodiments of exacta bet entry pages 600a and 600b are illustrated. The exacta requires a selection to be made in the ‘first’ column 610 and another selection in the ‘with’ column 620, as shown in view 600a. One selection in each meets the minimum requirements for an exacta. In this embodiment, the application further allows these two selections to be “boxed” by pressing a box button 615, which effectively creates a second exacta bet. For example, a 4/7 exacta requires racer 4 to finish first and racer 7 to finish second, while a 4/7 boxed places two bets, one on the sequence just described, and a second on racer 7 to finish first and racer 4 to finish second. As above, details may be shown in a bet details portion 625.

The application also preferably permits full-cover permutations by use of the boxed facility. For example, a 4/7/8 full-cover boxed exacta covers any two of the three racers finishing first and second in any order (e.g., 4/7, 7/4, 4/8, 8/4, 7/8 and 8/7). The application also preferably permits non-full-cover permutations. For example, in a ‘4, 7/8’ bet, a winning bet has racer 8 finishing second and either racer 4 or racer 7 finishing first. The boxed and multiple selection concept also preferably applies to quinella, trifecta, superfecta, etc.

Referring next to view 600b, exacta and quinella wagering, for example, may be displayed in an alternative view. In this embodiment, a matrix detailing all possible permutations is displayed. Each element preferably shows either the pool total or the probable payout assigned to that outcome. The pools may be updated as desired from the data feed received, and therefore the probable payout tends to become more accurate as the time for pool closure nears.

As illustrated in this embodiment, the left-hand column shows the 1^{st} position 630, while the top row shows the 2^{nd} position 640. Reading down and across gives either the probable payout or the pool total for the element. The quinella may use a similar architecture if desired. However, rather than selecting 1^{st} and 2^{nd}, the user can preferably click on the required combination, which writes the bet detail in the previously described fashion. On the exacta and quinella interface, the user can further preferably toggle, between a “grid” view and a “standard” view as desired.

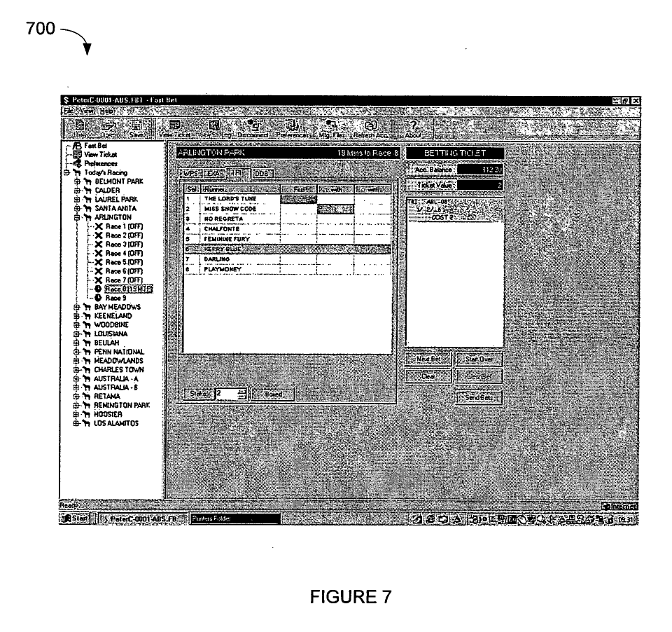

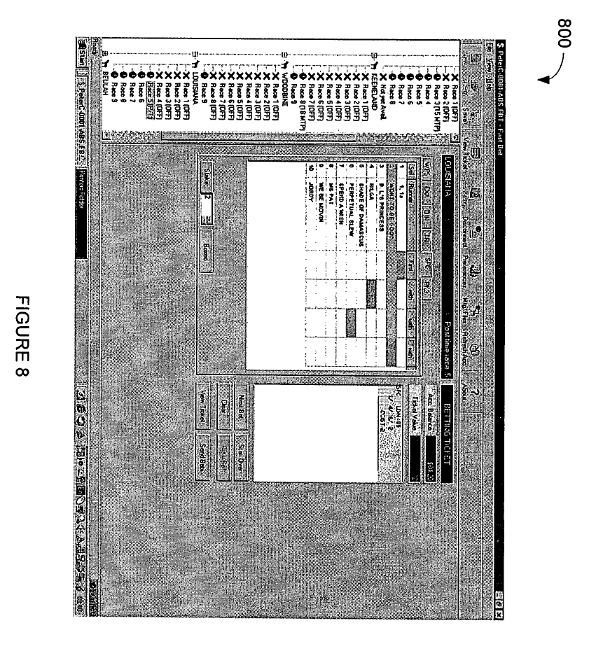

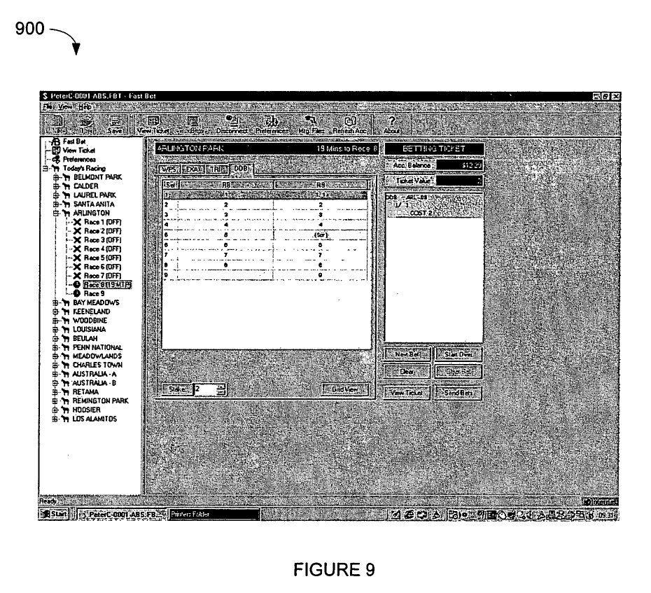

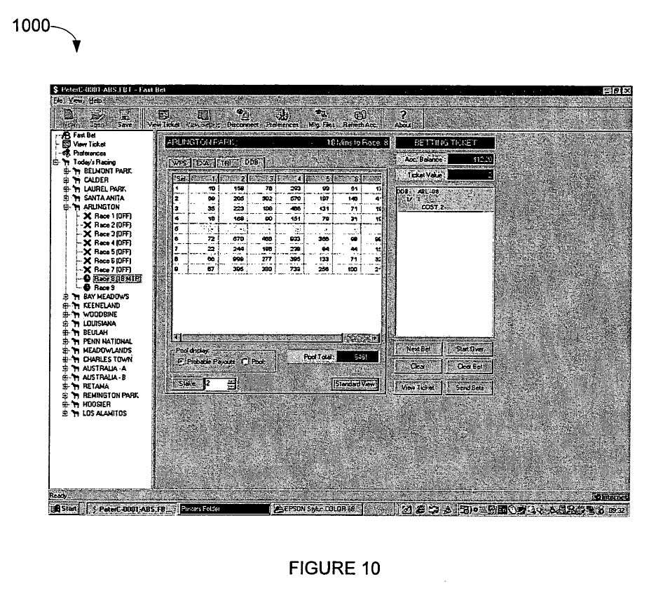

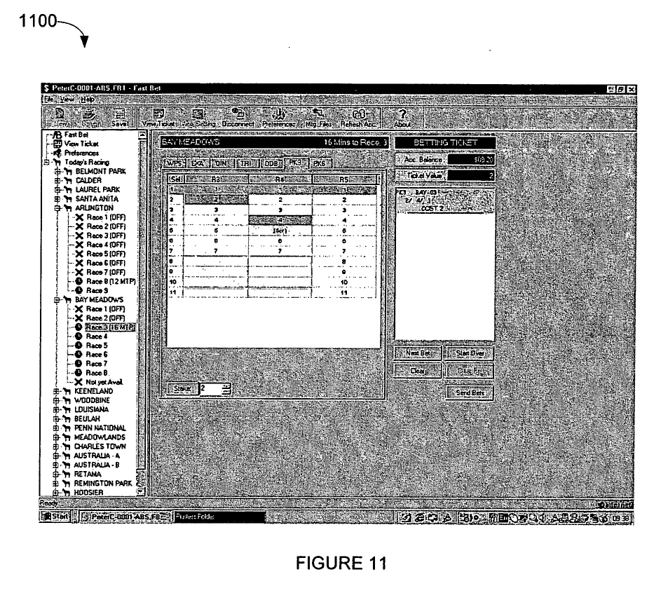

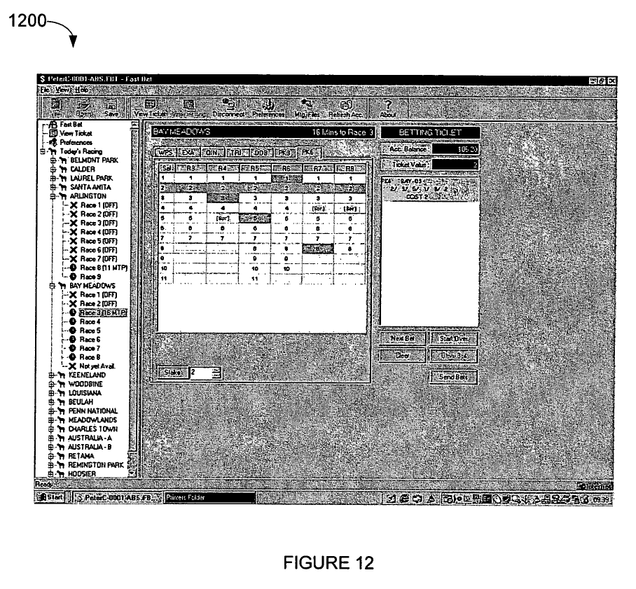

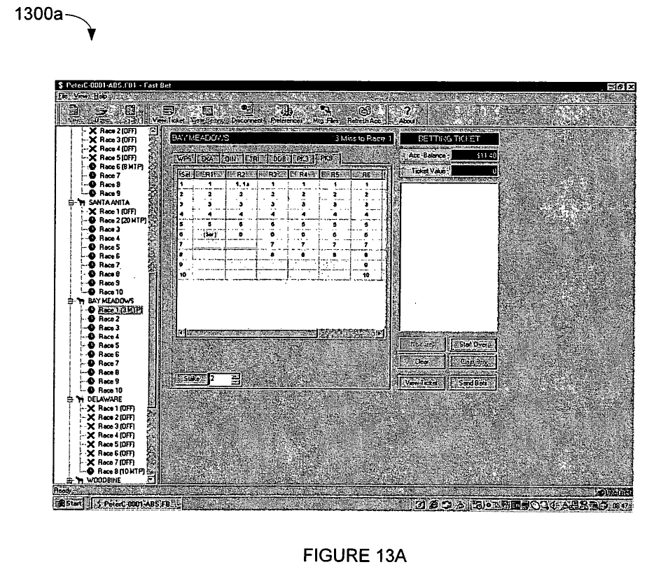

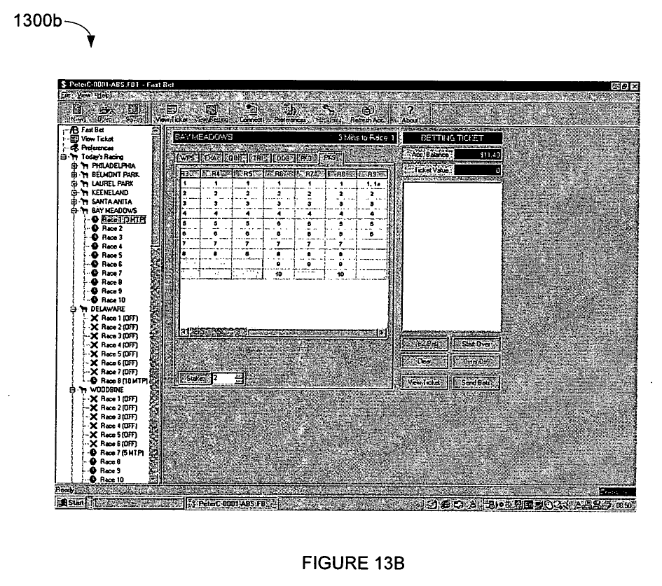

For illustrative purposes only, FIGS. 7-12, 13A and 13B illustrate embodiments of views that may be provided for additional bet types, including trifecta 700 (FIG. 7), superfecta 800 (FIG. 8), daily double 900 (FIG. 9), daily double grid 1000 (FIG. 10), pick 3 1100 (FIG. 11), pick 6 1200 (FIG. 12) and two embodiments 1300a and 1300b of a pick 9 view (FIGS. 13A and 13B).

Conclusion

While various embodiments of the present invention have been described above, it should be understood that they have been presented by way of example only, and not limitation. For example, the present invention is not limited to the physical arrangements described or use with any particular network or data format. Likewise, the invention, while described in part with respect to wagering on racing events, is applicable to any wagering environment. As such, the breadth and scope of the present invention should not be limited to any of the above-described exemplary embodiments.

1. A system for interactive wagering on an event from a remote location over a network, comprising:
a general purpose personal computing device in communication with the network, the general-purpose computing device providing a user-customizable personalized wagering experience;
a wager server, in communication with the general-purpose computing device over the network, for receiving wager information related to the event from a user;
an event location device, in communication with the wager server over the network, for compiling results information related to the event and providing settlement information related to wagers placed.

2. The system of claim 1, further comprising:
a financial center, in communication with the network, for supporting an account of the user and receiving the settlement information from the event location device; wherein the account of the user is debited based on unsuccessful wagers and credited based on successful wagers.

3. The system of claim 1, further comprising:
a receipt printer for issuing receipts and a barcode scanner for scanning issued receipts, the receipt printer and the barcode scanner providing data to the general-purpose personal computing device.

4. The system of claim 3, wherein the system is adapted for use by a retail user.

5. The system of claim 1, further comprising:
a credit card reader in communication with the general-purpose personal computing device for enabling the system for credit card transactions.

6. The system of claim 1, the general-purpose personal computing device comprising a personal computer running software customizable by the user, wherein the personal computer enables the user to save one or more wagers for future placement or repeat placement.

7. The system of claim 1, wherein the wager server communicates with a plurality of users using a plurality of general-purpose personal computing devices, and with a plurality of event location devices, thereby enabling wagering on a plurality of remote events.

8. The system of claim 7, further comprising:
a plurality of wager servers.

9. The system of claim 1, wherein the general-purpose personal computing device provides the user-customizable personalized wagering experience by communication with the wager server, wherein the manner in which content served by the wager server is controllable by the user.
